(19) United States
(12) Patent Application Publication
(10) Pub. No.: US 2022/0311534 A1
(43) Pub. Date: Sep. 29, 2022

(54) OPTICAL TRANSMITTER AND TRANSMISSION DEVICE

(71) Applicant: FUJITSU LIMITED, Kawasaki-shi (JP)

(72) Inventors: Yohei SOBU, Chiyoda (JP); Shinsuke Tanaka, Hiratsuka (JP); Tomoyuki Akiyama, Yokohama (JP); Hisao Nakashima, Kawasaki (JP)

(73) Assignee: FUJITSU LIMITED, Kawasaki-shi (JP)

(21) Appl. No.: 17/549,938

(22) Filed: Dec. 14, 2021

(30) Foreign Application Priority Data
Mar. 26, 2021 (JP) 2021-052659

(51) Int. Cl. H04J 14/02; H04B 10/516

(52) U.S. Cl. CPC H04J 14/0221; H04B 10/5161; H04J 14/0212

(57) ABSTRACT

An optical transmitter includes: an optical modulator including a pair of waveguides of a Mach-Zehnder interferometer to which signal light is input, and a plurality of optical phase shifters that are provided in each of the pair of waveguides and that each modulate a phase of the signal light with a plurality of drive signals; a plurality of drivers that generate the plurality of drive signals based on a plurality of digital signals corresponding to a symbol to which data signals are mapped and output the plurality of drive signals to the plurality of optical phase shifters, respectively; and a processor that shapes a waveform of the signal light such that a bandwidth of a spectrum of the signal light modulated by the optical modulator is equal to or less than a bandwidth corresponding to a rate of the symbol.

### CROSS-REFERENCE TO RELATED APPLICATION

This application is based upon and claims the benefit of priority of the prior Japanese Patent Application No. 2021-52659, filed on Mar. 26, 2021, the entire contents of which are incorporated herein by reference.

### FIELD

Embodiments discussed herein are related to an optical transmitter and a transmission device.

### BACKGROUND

In a large-capacity transmission system such as a digital coherent transmission system, data signals to be transmitted are mapped to a symbol in accordance with a multilevel modulation method such as 64 quadrature amplitude modulation (QAM), for example, and digital signal processing such as waveform shaping and equalization processing is performed on the data signals. In a common optical transmitter, a digital signal output from a digital signal processor (DSP) is converted into an electrical analog signal by a digital-to-analog converter (DAC), and the electrical analog signal is amplified by an analog driver to generate a drive signal having an amplitude of several volts. By driving an optical modulator with the drive signal, a modulated optical signal is output.

Japanese National Publication of International Patent Application No. 2018-523857 is disclosed as related art.

### SUMMARY

According to an aspect of the embodiments, an optical transmitter includes: an optical modulator including a pair of waveguides of a Mach-Zehnder interferometer to which signal light is input, and a plurality of optical phase shifters that are provided in each of the pair of waveguides and that each modulate a phase of the signal light with a plurality of drive signals; a plurality of drivers that generate the plurality of drive signals based on a plurality of digital signals corresponding to a symbol to which data signals are mapped and output the plurality of drive signals to the plurality of optical phase shifters, respectively; and a processor that shapes a waveform of the signal light such that a bandwidth of a spectrum of the signal light modulated by the optical modulator is equal to or less than a bandwidth corresponding to a rate of the symbol.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating a transmission device of a first comparative example;

FIG. 2 is a configuration diagram illustrating a transmission device of a second comparative example;

FIG. 3 is a configuration diagram illustrating a transmission device of a first embodiment;

FIG. 4 is a configuration diagram illustrating an example of a thermometer-type optical DAC;

FIG. 5 is a diagram illustrating an example of changes in power consumption and the number of segments of a segment optical modulator with respect to the number of bits;

FIG. 6 is a configuration diagram illustrating an example of a spectrum shaping unit;

FIG. 7 is a diagram illustrating an example of signal waveforms in the first embodiment;

FIG. 8 is a diagram illustrating an example of signal waveforms in the second comparative example;

FIG. 9 is a configuration diagram illustrating a transmission device of a second embodiment;

FIG. 10 is a configuration diagram illustrating an example of an equalizer;

FIG. 11 is a configuration diagram illustrating a transmission device of a third embodiment;

FIG. 12 is an equivalent circuit diagram illustrating an example of an equalizer;

FIG. 13 is a configuration diagram illustrating a transmission device of a fourth embodiment;

FIG. 14 is a configuration diagram illustrating a transmission device of a fifth embodiment;

FIG. 15 is a configuration diagram illustrating a transmission device of a sixth embodiment;

FIG. 16 is a configuration diagram illustrating a transmission device of a seventh embodiment;

FIG. 17 is a configuration diagram illustrating an example of a multifunction optical filter;

FIG. 18 is a configuration diagram illustrating an example of an optical processing unit having a two-stage configuration;

FIG. 19 is a configuration diagram illustrating an example of an optical processing unit having a five-stage configuration;

FIG. 20 is a configuration diagram illustrating an example of a binary-weighted optical DAC;

FIG. 21 is a configuration diagram illustrating an example of an optical DAC that performs weighting based on a voltage amplitude;

FIG. 22 is a configuration diagram illustrating an example of an optical DAC corresponding to a 5-bit symbol signal; and

FIG. 23 is a configuration diagram illustrating an example of an optical DAC corresponding to a 2-bit symbol signal.

### DESCRIPTION OF EMBODIMENTS

Application of an optical digital-to-analog converter (DAC) technology has been studied as an architecture that generates multilevel modulated optical signals by simply inputting digital signals in order to reduce power consumption of optical transmitters. In the optical DAC technology, a drive signal generated from a digital signal for each bit in accordance with a symbol is input from a binary driver to a segment (optical phase shifter) of a lumped-type segment optical modulator to optically convert the digital signal into an analog signal. For this reason, since a digital signal does not have to be converted into an analog signal by the DAC to output a drive signal having a large amplitude from the linear driver, power consumption is reduced.

For example, in wavelength multiplexing optical transmission, as a bandwidth of a spectrum of an optical signal of each wavelength is narrower, a larger number of optical signals may be wavelength-multiplexed, and thus a transmission capacity increases. For example, Nyquist filtering using a filter circuit is performed on a digital signal in order to reduce a bandwidth of a spectrum of an optical signal.

However, in a case where the optical DAC is used, similarly to an electric DAC, input of a digital signal at a sampling rate (for example, twice the symbol rate) equal to or higher than the symbol rate (baud rate) and, for example, at high resolution (for example, 5 bits or higher) is demanded. Accordingly, since it is desired to increase the number of segments of the lumped-type segment optical modulator, there is a risk that a circuit scale increases and power consumption increases. In a case where the sampling rate is high, since an optical modulator having a wide bandwidth has to be used, there is a risk that the modulation efficiency is significantly reduced due to a trade-off between the band and the modulation efficiency of the optical modulator.

An object of the present disclosure is to provide an optical transmitter and a transmission device capable of suppressing a decrease in modulation efficiency and reducing power consumption.

### COMPARATIVE EXAMPLES

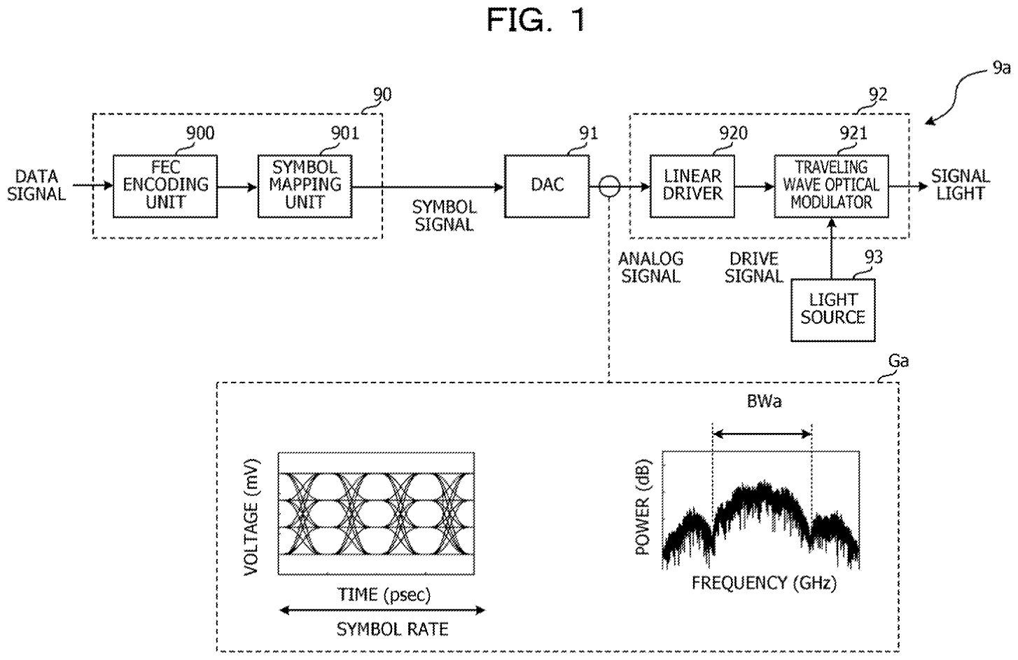

FIG. 1 is a configuration diagram illustrating a transmission device 9a of a first comparative example. As an example, the transmission device 9a includes a signal processing unit 90, a DAC 91, an optical transmitter 92, and a light source 93, and performs digital coherent optical transmission.

The signal processing unit 90 is, for example, a circuit including a DSP or the like. The signal processing unit 90 includes a forward error correction (FEC) encoding unit 900 and a symbol mapping unit 901.

The FEC encoding unit 900 encodes a data signal such as an Ethernet (registered trademark, the same applies hereinafter) signal to generate a parity bit used for error correction. The FEC encoding unit 900 assigns a parity bit to a data signal and outputs the data signal to the symbol mapping unit 901.

The symbol mapping unit 901 is an example of a mapping unit that maps a data signal to a symbol. The symbol mapping unit 901 maps the data signal to a symbol according to a multilevel modulation method such as 64QAM, for example. The symbol mapping unit 901 allocates a symbol defined as a signal point over the IQ plane in accordance with the value of the data signal, for example.

In this way, the symbol mapping unit 901 generates a plurality of symbol signals indicating the symbol for the respective bits. For example, in a case where the modulation method is 64QAM, symbol signals for 3 bits are generated, and in a case where the modulation method is 16QAM, symbol signals for 2 bits are generated. The plurality of symbol signals are an example of a plurality of digital signals corresponding to a symbol to which data signals are mapped. Each symbol signal is input to the DAC 91.

The DAC 91 converts a plurality of symbol signals into a plurality of electrical analog signals, respectively. Reference sign Ga indicates a temporal change (eye patterns) in voltage and a frequency spectrum of a symbol signal output from the DAC 91. It is assumed that the symbol signals are PAM (Pulse Amplitude Modulation) 4 signals as an example.

The DAC 91 samples each symbol signal at the same sampling rate as the symbol rate (baud rate). At this time, the bandwidth of the symbol signal is referred to as BWa. The DAC 91 outputs a plurality of analog signals to the optical transmitter 92.

The optical transmitter 92 performs optical modulation with a plurality of analog signals and transmits signal light. An optical transmitter 92 includes a linear driver 920 and a traveling wave optical modulator 921.

The linear driver 920 converts each analog signal into a drive signal having a large amplitude and outputs the drive signal to the traveling wave optical modulator 921. The traveling wave optical modulator 921 optically modulates signal light input from the light source 93 such as a laser diode with a drive signal. In accordance with the drive signal, the traveling wave optical modulator 921 applies an electric field to a waveguide for the signal light to change the refractive index of the signal light, thereby performing optical modulation. The traveling wave optical modulator 921 transmits the signal light to a transmission path such as an optical fiber.

For example, in wavelength multiplexing optical transmission, as a bandwidth of a spectrum of an optical signal of each wavelength is narrower, a larger number of optical signals may be wavelength-multiplexed, and thus a transmission capacity increases. For this reason, for example, Nyquist filtering using a filter circuit is performed on the symbol signal so as to reduce the bandwidth of the spectrum of the optical signal.

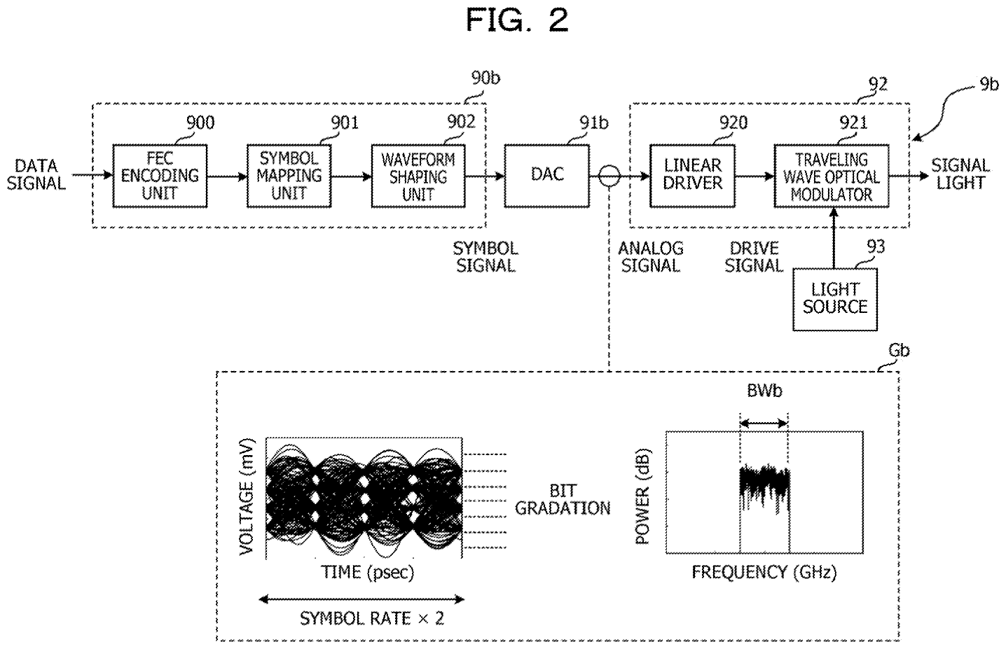

FIG. 2 is a configuration diagram illustrating a transmission device 9b of a second comparative example. As an example, the transmission device 9b includes a signal processing unit 90b, a DAC 91b, an optical transmitter 92, and a light source 93, and performs digital coherent optical transmission. In FIG. 2, the same configurations as those in FIG. 1 are denoted by the same reference signs, and description thereof is omitted.

The signal processing unit 90b is achieved by a circuit including a DSP or the like, for example, and includes an FEC encoding unit 900, a symbol mapping unit 901, and a waveform shaping unit 902. The waveform shaping unit 902 performs Nyquist filtering or the like on each symbol signal input from the symbol mapping unit 901, and performs waveform shaping so as to narrow the bandwidth.

The DAC 91b converts a plurality of symbol signals into a plurality of electrical analog signals. A reference sign Gb indicates a temporal change in voltage and a frequency spectrum of symbol signals output from the DAC 91b. It is assumed that the symbol signals are PAM4 signals as an example.

The DAC 91b samples each symbol signal at a sampling rate that is twice or more the symbol rate (baud rate), for example. Since the waveform of the symbol signals is complicated by the shaping by the waveform shaping unit 902 in the DAC 91b, the detection is performed for each sampling cycle based on the bit gradation defined by finely dividing the voltage level such that the waveform is reproduced in the reception device. In this way, the bandwidth BWb of the symbol signals is narrower than the bandwidth BWa in the case of the DAC 91 of the first comparative example. The DAC 91b outputs a plurality of analog signals to the optical transmitter 92.

### First Embodiment

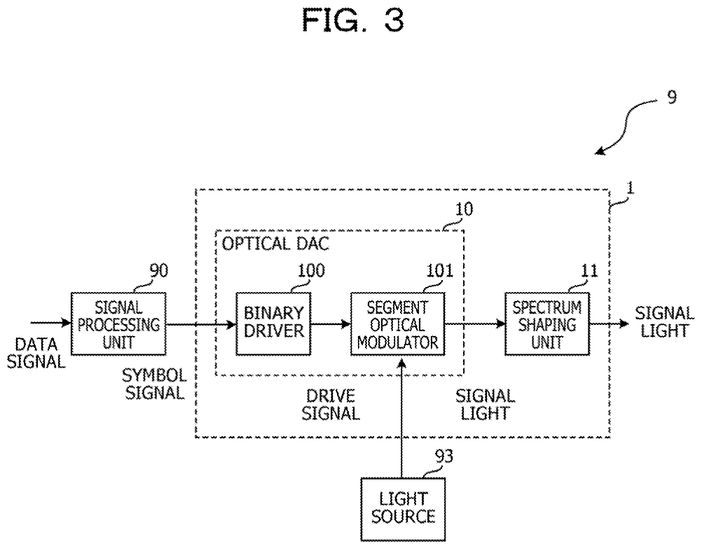

FIG. 3 is a configuration diagram illustrating a transmission device 9 of a first embodiment. In FIG. 3, the same configurations as those in FIG. 1 are denoted by the same reference signs, and description thereof is omitted. As an example, the transmission device 9 includes a signal processing unit 90, an optical transmitter 1, and a light source 93, and performs digital coherent optical transmission. The transmission device 9 reduces the number of bits and a sampling rate of a symbol signal by performing waveform shaping in the optical transmitter 1 but not performing waveform shaping in the signal processing unit 90.

The signal processing unit 90 outputs a plurality of symbol signals corresponding to the symbol to the optical transmitter 1. The optical transmitter 1 includes an optical DAC 10 and a spectrum shaping unit 11. The optical DAC 10 includes a binary driver 100 and a lumped-type segment optical modulator 101 (hereafter referred to as a segment optical modulator).

Based on the plurality of symbol signals input from the signal processing unit 90, the binary driver 100 generates a plurality of drive signals, respectively, and outputs the drive signals to the segment optical modulator 101. The binary driver 100 generates a drive signal having an amplitude smaller than that of the linear driver 920 of the comparative examples. Each of the drive signals is a digital signal indicating a voltage level of “0” or “1”. For this reason, the power consumption of the binary driver 100 is lower than that of the linear driver 920.

The segment optical modulator 101 optically modulates signal light input from the light source 93 with a plurality of drive signals output from the binary driver 100. The segment optical modulator 101 outputs the optically modulated signal light to the spectrum shaping unit 11. The spectrum shaping unit 11 shapes a waveform of signal light so as to narrow a bandwidth of the signal light. An example of the optical DAC 10 and the spectrum shaping unit 11 will be described below.

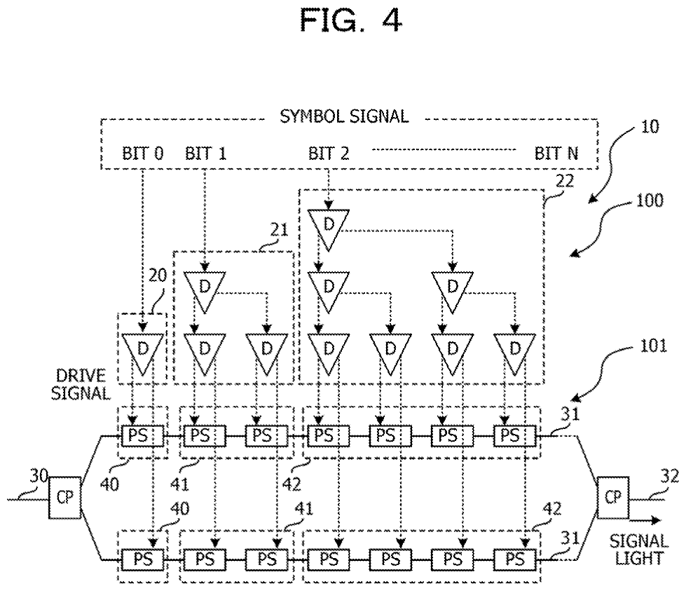

FIG. 4 is a configuration diagram illustrating an example of a thermometer-type optical DAC 10. Symbol signals of bits 0 to N (N is an integer of 2 or more) are input to the binary driver 100. The binary driver 100 includes drive circuits 20 to 22 that each generate a drive signal from a symbol signal of each bit. The drive circuits 20 to 22 respectively correspond to the symbol signals of bits 0 to 2. Illustration of drive circuits for bits 3 to N is omitted.

Each of the drive circuits 20 to 22 includes driver elements D the number of which corresponds to the symbol signals of bits 0 to 2. The number of driver elements D in the drive circuits 20 to 22 is determined for each of bits 0 to 2. Although the drive circuit 20 for bit 0 includes one driver element D, each of the drive circuits 21 and 22 for bit 1 and bit 2 includes a plurality of driver elements D configured in multiple stages. The driver element D is a device having one input and two outputs, and performs shaping of a drive signal, giving of a delay, adjustment of an amplitude, adjustment of a bias, and the like. The driver element D in the final stage outputs a drive signal to the segment optical modulator 101. The configuration of the driver element D is not limited to this example.

The segment optical modulator 101 has a configuration of a Mach-Zehnder interferometer including an input waveguide 30, a pair of branch waveguides 31, and an output waveguide 32. Each of the input waveguide 30 and the output waveguide 32 is coupled to the pair of branch waveguides 31 via an optical coupler CP. Signal light is input from the light source 93 to the input waveguide 30, passes through the pair of branch waveguides 31, and is output from the output waveguide 32. The pair of branch waveguides 31 are an example of a pair of waveguides of a Mach-Zehnder interferometer to which signal light is input. The segment optical modulator 101 is an example of an optical modulator.

Each branch waveguide 31 is provided with the same number of optical phase shifters PS. Each optical phase shifter PS coincides with a segment over the branch waveguide 31 and has the same length (segment length) as each other.

The driver elements D at the final stage of the drive circuits 20 to 22 output drive signals to the optical phase shifters PS of the respective branch waveguides 31. For example, the optical phase shifter PS applies an electric field to the branch waveguide 31 in accordance with the drive signal to change the refractive index of the signal light, thereby modulating the phase of the signal light.

Each of groups 40 to 42 of the optical phase shifters PS corresponding to the drive circuits 20 to 22 is an example of a plurality of optical phase shift units. The drive circuits 20 to 22 are an example of a plurality of drive units that generate a plurality of drive signals based on the plurality of symbol signals and respectively output the drive signals to the groups 40 to 42 of the optical phase shifters PS. The number of optical phase shifters PS in each of the groups 40 to 42 varies depending on bits 0 to 2. In the configuration of this example, the number of optical phase shifters PS in the group 40 to 42 of the bit I (positive integer) is 2ⁱ⁻¹.

As the number of bits increases in this manner, the number of segments of the optical phase shifter PS increases.

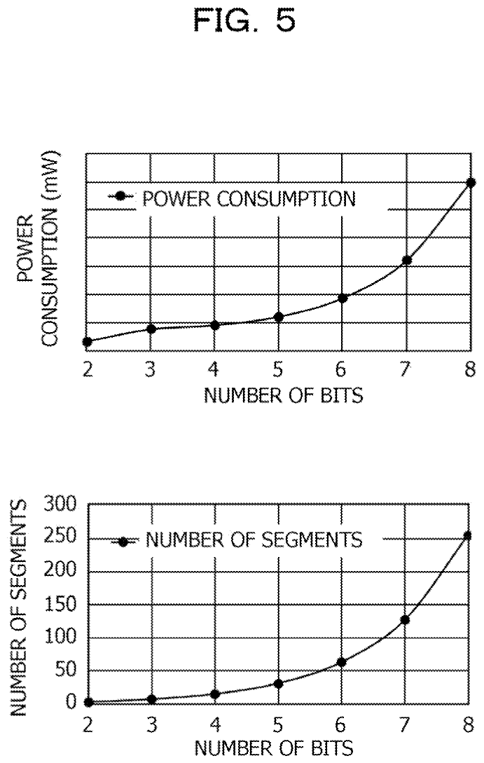

FIG. 5 is a diagram illustrating an example of changes in power consumption (mW) and the number of segments of the segment optical modulator 101 with respect to the number of bits N. The power consumption of the segment optical modulator 101 increases as the number of bits N increases. For example, when the number of bits exceeds 5, the power consumption significantly increases.

When the number of segments increases in accordance with the number of bits N, for example, the number of terminals coupled to the binary driver 100 or the like increases, so that the circuit scale increases, the power consumption increases, and the difficulty of implementation also increases.

For example, in a case where the waveform shaping unit 902 of the second comparative example is provided in the optical transmitter 1, similarly to the electric DAC, input of drive signals at a sampling rate (for example, twice the symbol rate) equal to or higher than the symbol rate (baud rate) and at a high resolution (for example, 5 bits or higher) is demanded for the optical DAC 10. Accordingly, since it is desirable to increase the number of segments of the segment optical modulator 101, there is a risk that the circuit scale increases and the power consumption increases. Since a high sampling rate is demanded for the optical DAC 10, the modulation efficiency may decrease due to a trade-off relationship between the bandwidth and the modulation efficiency of the segment optical modulator 101.

For this reason, the optical transmitter 1 includes the spectrum shaping unit 11 that shapes an optical signal, instead of the waveform shaping unit 902. The spectrum shaping unit 11 shapes a waveform of signal light so that a bandwidth of a spectrum of the signal light modulated by the segment optical modulator 101 is equal to or less than a bandwidth corresponding to a rate of a symbol.

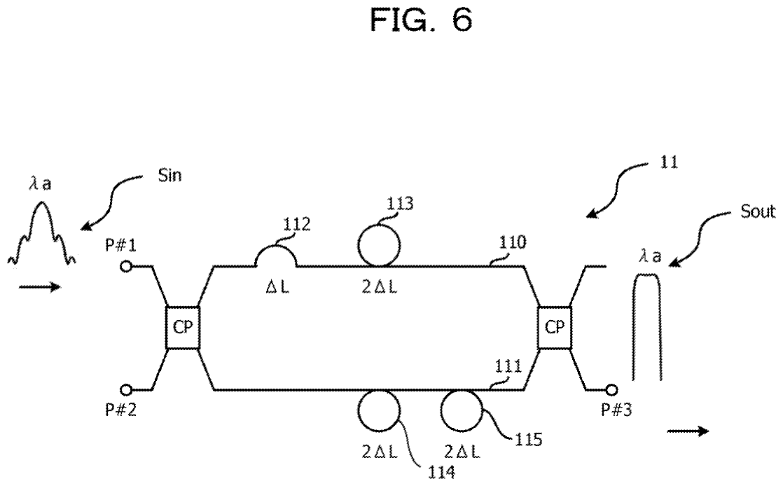

FIG. 6 is a configuration diagram illustrating an example of the spectrum shaping unit 11. As an example, the spectrum shaping unit 11 is achieved by a Nyquist filtering optical multiplexer and demultiplexer having a structure of an asymmetric Mach-Zehnder interferometer. The spectrum shaping unit 11 includes input ports P#1 and P#2, an output port P#3, a pair of waveguides 110 and 111, a delay unit 112, ring resonators 113 to 115, and optical couplers CP.

The input ports P#1 and P#2 and the output port P#3 are coupled to the pair of waveguides 110 and 111 via the optical couplers CP. A delay ΔL of an optical path length and the ring resonator 113 are provided in one waveguide 110, and the ring resonators 114 and 115 are provided in the other waveguide 111. Each of the ring resonators 113 to 115 has a circumference of 2ΔL and functions as an infinite impulse response filter. Each of the ring resonators 113 to 115 performs Nyquist filtering on the signal light input from the input ports P#1 and P#2.

For example, in a case where the signal light Aa is input to the input port P#1 (see reference sign Sin), the signal light Aa is subjected to Nyquist filtering, and thus the signal light Aa shaped into a rectangular Nyquist band is output from the output port P#3 (see reference sign Sout). In this way, since the spectrum shaping unit 11 performs the Nyquist filtering on the signal light beams Aa to Ad, it is possible to narrow the bandwidth of the signal light Aa to the Nyquist band.

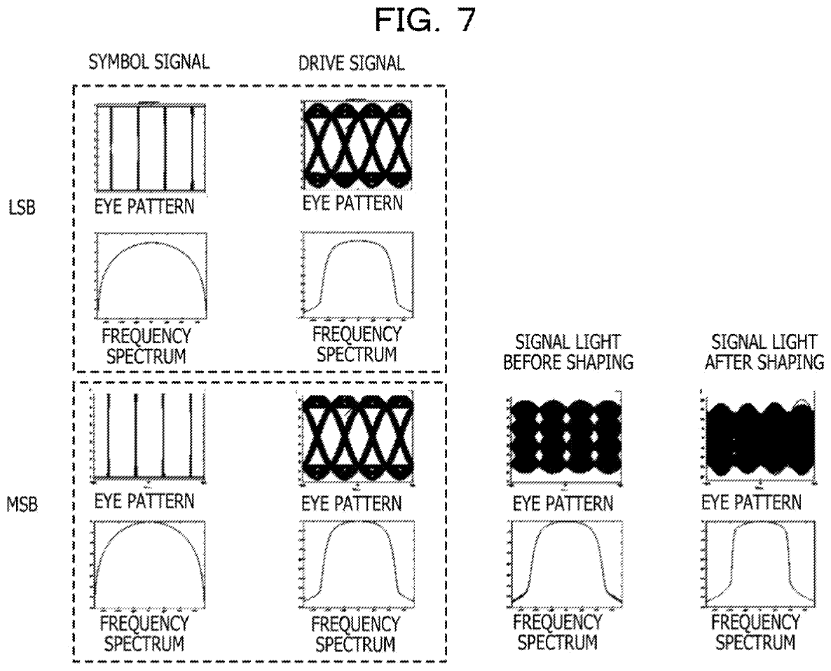

FIG. 7 is a diagram illustrating an example of signal waveforms in the first embodiment. FIG. 7 illustrates eye patterns and frequency spectra of symbol signals and drive signals of the least significant bit (LSB) and the most significant bit (MSB) in the transmission device 9 illustrated in FIG. 3, and eye patterns and frequency spectra of signal light before and after shaping by the spectrum shaping unit 11.

It is assumed that the binary driver 100 is a low-pass filter that reduces signal power by 3 (dB) at the Nyquist frequency. It is assumed that the segment optical modulator 101 has a response characteristic of a Sin curve. The segment optical modulator 101 combines the signal light of the LSB and the signal light of the MSB. It is assumed that the spectrum shaping unit 11 is an ideal Nyquist filter.

The bandwidth of the symbol signal output from the signal processing unit 90 corresponds to the bandwidth corresponding to a symbol rate. For this reason, the binary driver 100 may sample each symbol signal at the same sampling rate as the symbol rate (1 sample/symbol). Accordingly, since the segment optical modulator 101 does not have to have an excessively wide analog band, a decrease in modulation efficiency is suppressed.

For reproduction of a waveform of an eye pattern of a symbol signal, bit gradation for finely dividing voltage levels does not have to be used. For this reason, the number of bits of the symbol signal may be set to a number according to the modulation method. For example, when 16QAM is used as the modulation method, the number of bits is 2 bits, and when 64QAM is used as the modulation method, the number of bits is 3 bits. Accordingly, the number of segments of the segment optical modulator 101 is minimized, and as compared with a case where the number of bits is larger than the number according to the modulation method, the power consumption of the segment optical modulator 101 may be effectively reduced.

As understood by comparing the frequency spectra of the signal light before and after the shaping, the spectrum shaping unit 11 is capable of narrowing the bandwidth of the signal light to a width corresponding to the symbol rate by the optical Nyquist filtering.

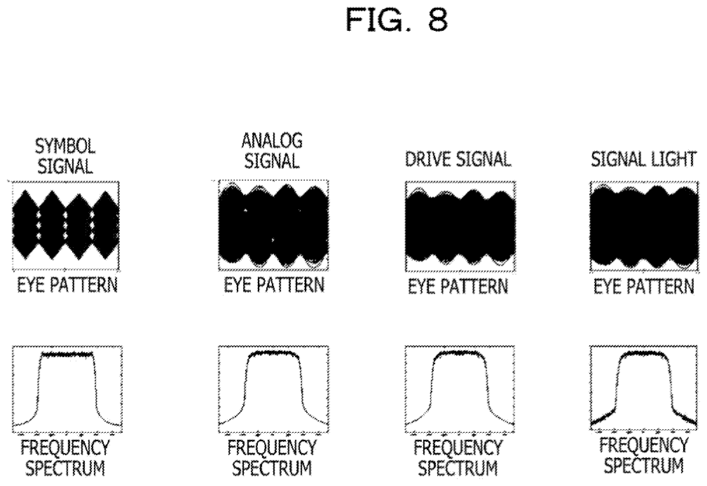

FIG. 8 is a diagram illustrating an example of signal waveforms in the second comparative example. FIG. 8 illustrates an eye pattern and frequency spectrum of each of symbol signals, analog signals, drive signals, and signal light in the transmission device 9b illustrated in FIG. 2.

The symbol signal is electrically subjected to Nyquist filtering by the waveform shaping unit 902. For this reason, the bandwidth in the frequency spectrum of the signal light is narrowed to a width corresponding to the symbol rate as in the first embodiment.

In this way, the spectrum shaping unit 11 shapes the waveform of the signal light so that the bandwidth of the spectrum of the signal light is equal to or less than the bandwidth corresponding to the symbol rate, instead of the waveform shaping unit 902. Accordingly, since the optical DAC 10 does not have to have a sampling rate higher than the symbol rate, a decrease in the modulation efficiency of the segment optical modulator 101 is suppressed. Since the number of symbol signals input to the optical DAC 10 is reduced because fine bit gradation as in the second comparative example is not used, the power consumption of the segment optical modulator 101 is reduced.

### Second Embodiment

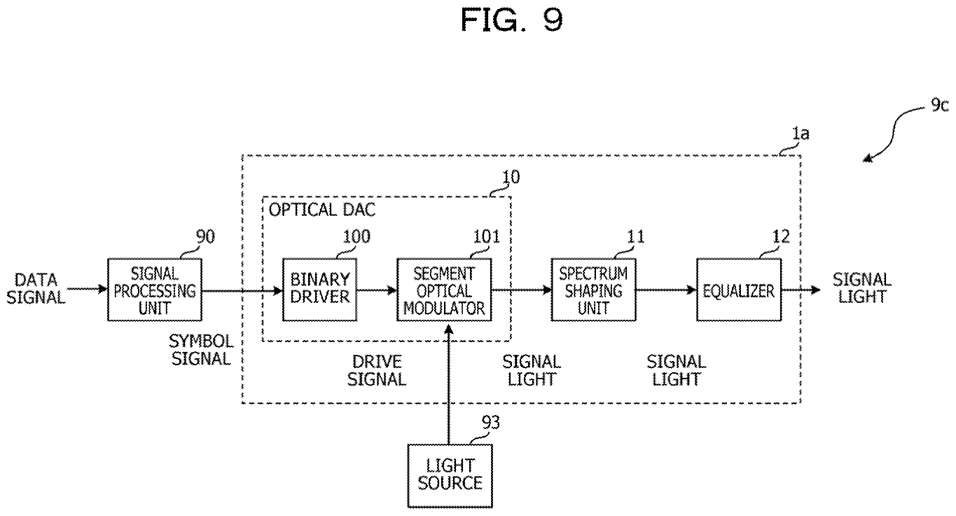

FIG. 9 is a configuration diagram illustrating a transmission device 9c according to a second embodiment. As an example, the transmission device 9c includes a signal processing unit 90, an optical transmitter 1a, and a light source 93, and performs digital coherent optical transmission. In FIG. 9, the same configurations as those in FIG. 3 are denoted by the same reference signs, and description thereof is omitted.

The optical transmitter 1a includes an optical DAC 10, a spectrum shaping unit 11, and an equalizer 12. The equalizer 12 is an example of a first equalization unit, and performs equalization processing on the signal light modulated by the segment optical modulator 101. In this way, since the optical transmitter 1a is capable of performing the equalization processing of the frequency response of the signal light, the transfer quality is improved.

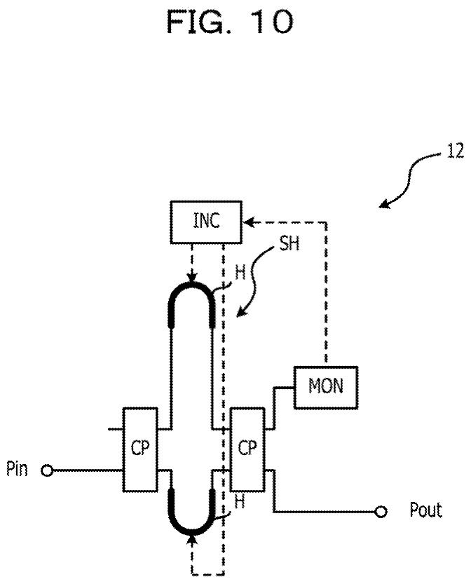

FIG. 10 is a configuration diagram illustrating an example of the equalizer 12. The equalizer 12 includes an input terminal Pin, an output terminal Pout, an optical phase shifter SH, a controller INC, a power detector MON, and two optical couplers CP.

The optical phase shifter SH is achieved by a pair of heaters H over a pair of waveguides of an asymmetric Mach-Zehnder interferometer, for example. As the temperature of the heater H increases, the optical path length of the waveguide increases, and thus the optical phase changes. The optical phase shifter SH is coupled to the input terminal Pin via the input-side optical coupler CP, and is coupled to the output terminal Pout and the power detector MON via the output-side optical coupler CP.

The optical phase shifter SH is controlled by the controller INC. The controller INC controls the temperatures of the pair of heaters H such that the input power increases in accordance with the output power of the signal light detected by the power detector MON.

### Third Embodiment

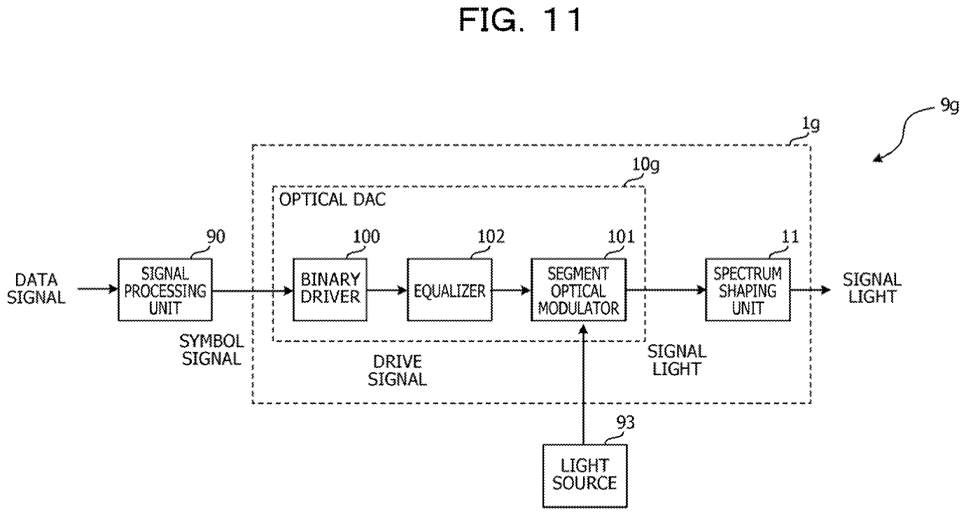

FIG. 11 is a configuration diagram illustrating a transmission device 9g according to a third embodiment. As an example, the transmission device 9g includes a signal processing unit 90, an optical transmitter 1g, and a light source 93, and performs digital coherent optical transmission. In FIG. 11, the same configurations as those in FIG. 3 are denoted by the same reference signs, and description thereof is omitted.

The optical transmitter 1g includes an optical DAC 10g and a spectrum shaping unit 11. The optical DAC 10g includes a binary driver 100, an equalizer 102, and a segment optical modulator 101.

The equalizer 102 is coupled between the binary driver 100 and the segment optical modulator 101. Unlike the equalizer 12 according to the second embodiment, the equalizer 102 performs electrical equalization processing. The equalizer 102 is an example of a second equalization unit, and performs equalization processing on a plurality of drive signals output from the binary driver 100 to the segment optical modulator 101. In this way, since the optical transmitter 1g is capable of performing the equalization processing of the frequency response of the signal light, the transfer quality is improved.

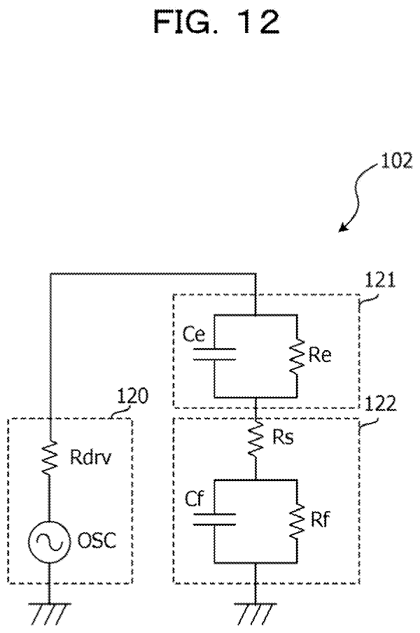

FIG. 12 is an equivalent circuit diagram illustrating an example of the equalizer 102. The equalizer 102 includes a driver 120, an RC equalizer 121, and a PIN phase shifter 122. The driver 120 includes an oscillator OSC and a resistor Rdrv coupled to each other in series. The RC equalizer 121 includes a capacitive element Ce and a resistor Re coupled to each other in parallel. The PIN phase shifter 122 includes a capacitive element Cf and a resistor Rf coupled to each other in parallel, and a resistor Rs coupled to one coupling point of the capacitive element Cf and the resistor Rf.

In the driver 120, one end of the oscillator OSC is grounded, and one end of the resistor Rdrv is coupled to one coupling point of the capacitive element Ce and the resistor Re. The other coupling point of the capacitive element Ce and the resistor Re is coupled to the resistor Rs. The other coupling point of the capacitive element Cf and the resistor Rf is grounded. The capacitive element Cf and the resistor Rf are disposed in a propagation path through which a signal propagates.

By being integrated together with the PIN phase shifter 122, the RC equalizer 121 may extend the bandwidth of the PIN phase shifter 122 and equalize signals in a wide frequency band. The technology described in the document “Y. Sobu, S. Tanaka, and Y. Tanaka, “High-Speed-Operation of All-Silicon Lumped-Electrode Modulator Integrated with Passive Equalizer”, IEICE Trans. Electron. E103.C, 11, pp. 619-626″ may also be adopted for the equalizer 102.

### Fourth Embodiment

It is also possible to perform equalization processing using both the electrical equalizer 102 and the optical equalizer 12 described above.

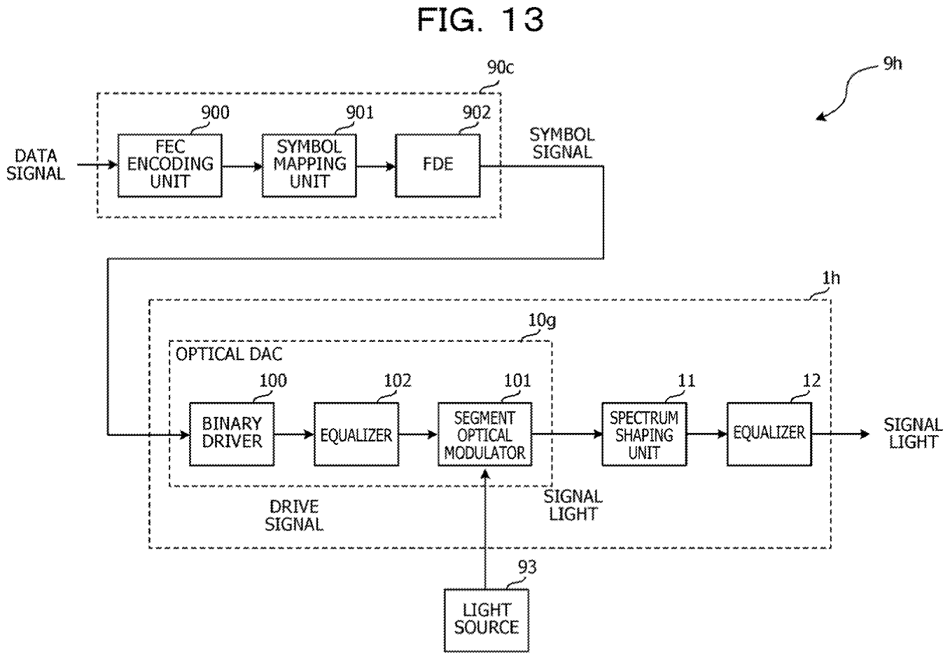

FIG. 13 is a configuration diagram illustrating a transmission device 9h according to a fourth embodiment. As an example, the transmission device 9h includes a signal processing unit 90c, an optical transmitter 1h, and a light source 93, and performs digital coherent optical transmission. In FIG. 13, the same configurations as those in FIGS. 1, 9, and 11 are denoted by the same reference signs, and description thereof is omitted.

The signal processing unit 90c is provided in place of the signal processing unit 90. The signal processing unit 90c includes an FEC encoding unit 900, a symbol mapping unit 901, and a frequency domain equalizer (FDE) 902.

The FDE 902 Is provided at a subsequent stage of the symbol mapping unit 901, and performs equalization processing on a symbol signal input from the symbol mapping unit 901. Examples of the equalization processing include, but are not limited to, pre-equalization processing of a transmission line, and the like. In this way, the FDE 902 may electrically improve the quality of the symbol signals.

The optical transmitter 1h includes an optical DAC 10g, a spectrum shaping unit 11, and an equalizer 12. The optical DAC 10g includes a binary driver 100, an equalizer 102, and a segment optical modulator 101.

Each of the equalization processing by the FDE 902 and the equalizer 12 and 102 is performed in cooperation with each other. In this way, it is possible to perform the equalization processing more effective than the second and third embodiments. The signal processing unit 90c including the FDE 902 may be provided in place of the signal processing unit 90 in each of the other embodiments. The FDE 902 is an example of a third equalization unit that performs equalization processing on a symbol output from the symbol mapping unit 901 to the binary driver 100.

### Fifth Embodiment

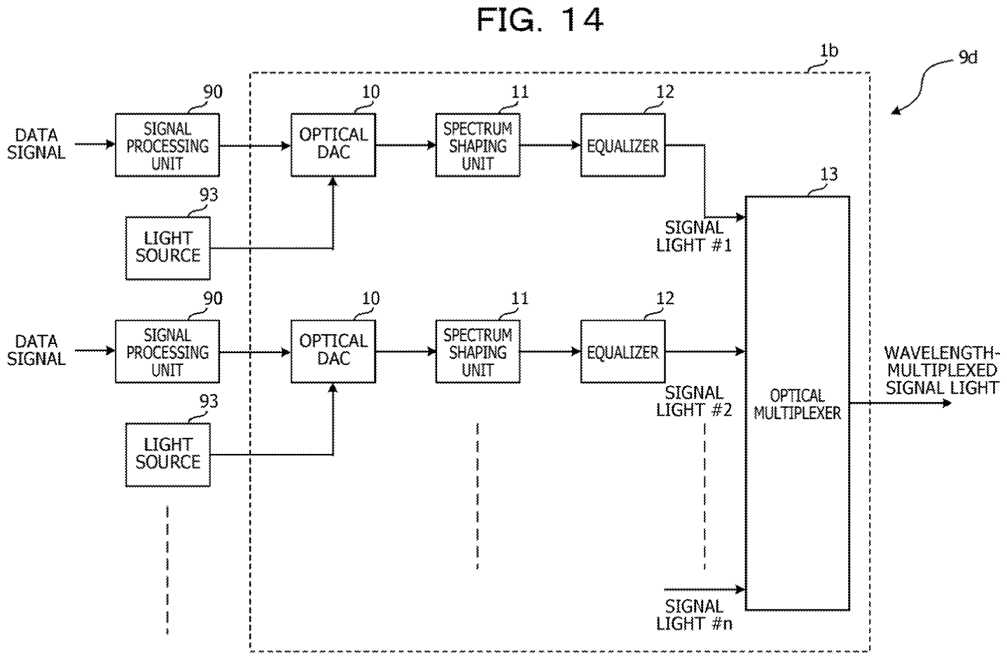

FIG. 14 is a configuration diagram illustrating a transmission device 9d according to the fifth embodiment. As an example, the transmission device 9d includes pluralities of signal processing units 90 and light sources 93, and an optical transmitter 1b, and performs wavelength multiplexing optical transmission on signal light beams #1 to #n (n is an integer of 2 or more) having different wavelengths. In FIG. 14, the same configurations as those in FIG. 9 are denoted by the same reference signs, and description thereof is omitted.

Each of the numbers of the signal processing units 90 and the light sources 93 provided is equal to the number of signals to be wavelength-multiplexed. The optical transmitter 1b includes n optical DACs 10, n spectrum shaping units 11, n equalizers 12, and an optical multiplexer 13 that multiplexes the signal light beams #1 to #n. The optical transmitter 1b may not include the equalizer 12.

The signal light beams #1 to #n are input to the optical multiplexer 13 from the n equalizers 12, respectively. The optical multiplexer 13 wavelength-multiplexes the signal light beams #1 to #n to generate wavelength-multiplexed signal light. The wavelength-multiplexed signal light is output from the optical multiplexer 13 to the transmission path.

As an example, the optical multiplexer 13 is achieved by an arrayed waveguide grating (AWG). An arrayed waveguide grating includes a plurality of waveguides having different lengths, and may extract light for each wavelength by using a spectral function. The optical multiplexer 13 is an example of a multiplexing unit that multiplexes signal light #α (α is a positive integer) with different signal light #β (β is a positive integer) having a wavelength different from the wavelength of the signal light #α.

The optical transmitter 1b may wavelength-multiplex the signal light beams #1 to #n into wavelength-multiplexed signal light by using the optical multiplexer 13. For this reason, the transmission capacity of the transmission device 9d increases as compared with the case where only signal light of one wavelength is transmitted. In the present example, n equalizers 102 may be provided in place of or in addition to the n equalizers 12.

### Sixth Embodiment

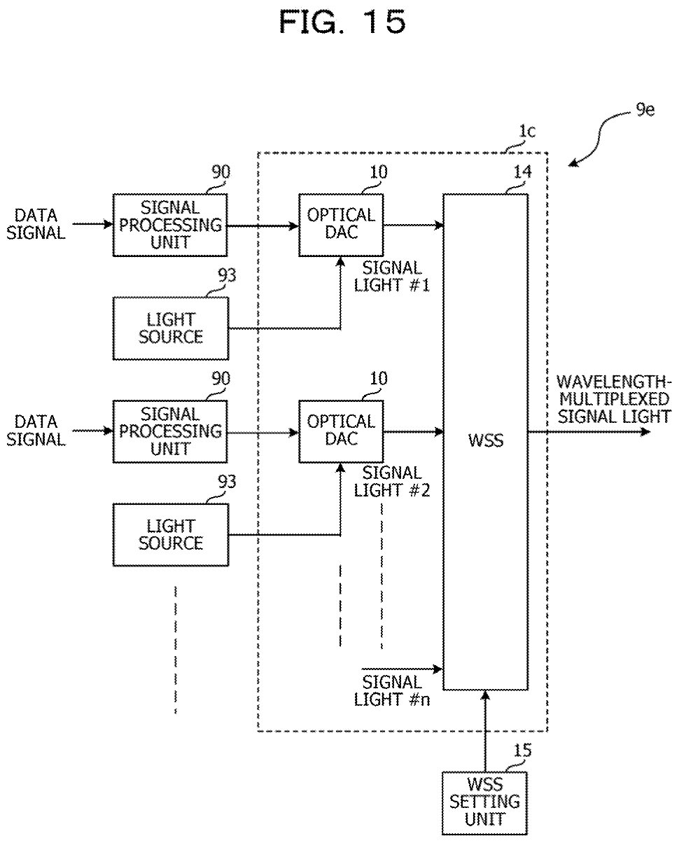

FIG. 15 is a configuration diagram illustrating a transmission device 9e according to a sixth embodiment. As an example, the transmission device 9e includes pluralities of signal processing units 90 and light sources 93, an optical transmitter 1c, and a wavelength selective switch (WSS) setting unit 15, and performs wavelength multiplexing optical transmission on signal light beams #1 to #n having different wavelengths. In FIG. 15, the same configurations as those in FIG. 14 are denoted by the same reference signs, and description thereof is omitted.

The optical transmitter 1c includes n optical DACs 10 and a wavelength selective switch (WSS) 14. To the WSS 14, the signal light beams #1 to #n are input from the n optical DACs 10, respectively. The WSS 14 generates wavelength-multiplexed signal light by filtering and wavelength-multiplexing each of the signal light beams #1 to #n. Wavelength-multiplexed signal light is output from the WSS 14 to the transmission path. The WSS setting unit 15 sets a passband for filtering each of the signal light beams #1 to #n in the WSS 14.

As the WSS 14, for example, a MEMS-type WSS, a liquid crystal on silicon (LCOS)-type WSS, or a waveguide-type WSS may be used. The MEMS-type WSS is described in, for example, the document “C.-H. Chi et al., OFC2006, OTuF1”. The LCOS-WSS is described in, for example, the document “G. Baxter, et al., OFC2006, OTuF2”. The waveguide-type WSS is described in, for example, the document “T. Goh, et al., OFC2006, OTuF3”.

In the WSS 14, the passband that allows each of the signal light beams #1 to #n to be transmitted is variable. For this reason, in accordance with the setting of the passband by the WSS setting unit 15, the WSS 14 may shape the waveform of each of the signal light beams #1 to #n such that the bandwidth of the spectrum of each of the signal light beams #1 to #n is equal to or less than the band corresponding to the symbol rate. For example, even in a case where the symbol rate is changed, the WSS 14 may narrow the bandwidth of the spectrum of each of the signal light beams #1 to #n in accordance with the setting of the passband corresponding to the changed symbol rate.

The WSS 14 may wavelength-multiplex the signal light beams #1 to #n into wavelength-multiplexed signal light. Accordingly, since the optical transmitter 1c does not have to be provided with n equalizers 12 and n optical multiplexers 13 as in the fifth embodiment, the scale of the device is reduced. In the present example, the above-described equalizer 12 may be provided between each optical DAC 10 and the WSS 14.

### Seventh Embodiment

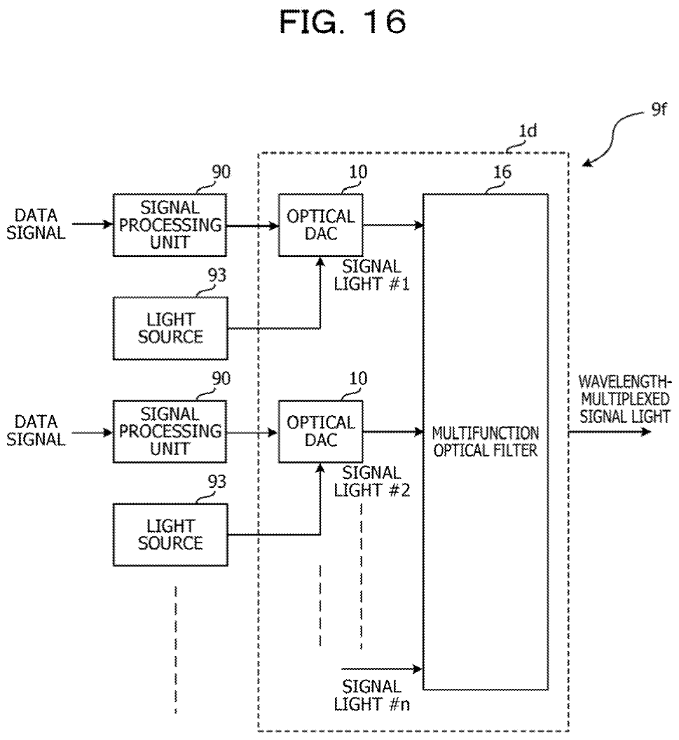

FIG. 16 is a configuration diagram illustrating a transmission device 9f according to a seventh embodiment. As an example, the transmission device 9f includes pluralities of signal processing units 90 and light sources 93, an optical transmitter 1d, and a multifunction optical filter 16, and performs wavelength multiplexing optical transmission on signal light beams #1 to #n having different wavelengths. In FIG. 16, the same configurations as those in FIG. 15 are denoted by the same reference signs, and description thereof is omitted.

The multifunction optical filter 16 performs spectrum shaping processing, equalization processing, and wavelength multiplexing processing on the signal light beams #1 to #n, for example. Optical circuits that perform these three processes are integrated over a common substrate, for example, as follows.

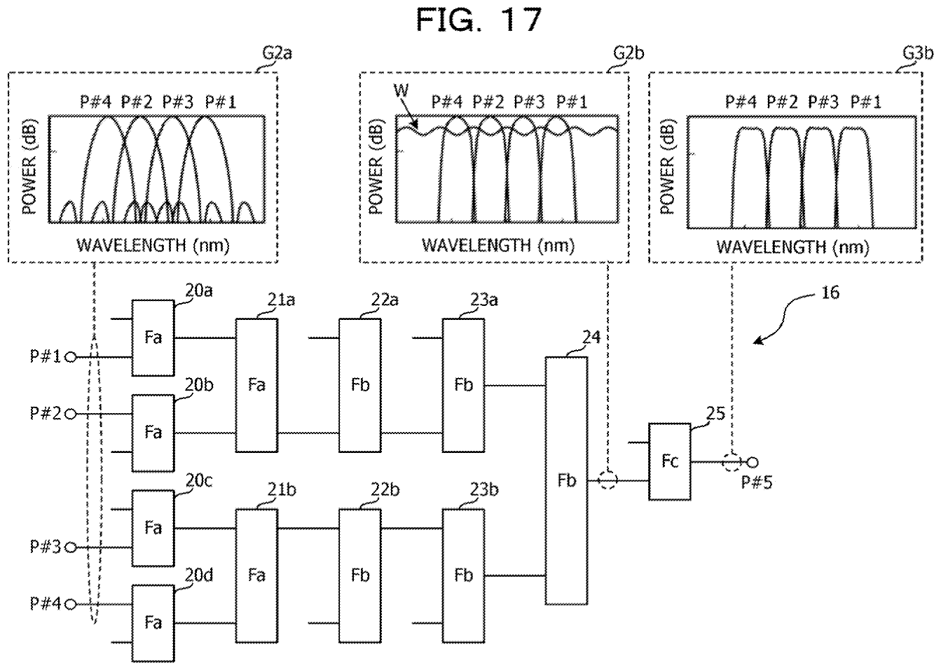

FIG. 17 is a configuration diagram illustrating an example of the multifunction optical filter 16. The multifunction optical filter 16 includes input ports P#1 to P#4, an output port P#5, optical processing units 20a to 20d, 21a, and 21b having a two-stage configuration Fa, optical processing units 22a, 22b, 23a, 23b, and 24 having a five-stage configuration Fb, and an optical processing unit 25 having a one-stage configuration Fc. Each of the optical processing units 20a to 20d, 21a, 21b, 22a, 22b, 23a, 23b, 24, and 25 is a two input and one output optical circuit, and is coupled in cascade in multiple stages as described below.

The input ports P#1 to P#4 are optically coupled respectively to one input terminals of the optical processing units 20a to 20d in the first stage. Output terminals of the optical processing units 20a and 20b are optically coupled respectively to two input terminals of the optical processing unit 21a in the second stage, and output terminals of the optical processing units 20c and 20d are optically coupled respectively to two input terminals of the optical processing unit 21b in the second stage. Output terminals of the optical processing units 21a and 21b are optically coupled respectively to one input terminals of the optical processing units 22a and 22b in the third stage.

Output terminals of the optical processing units 22a and 22b are optically coupled respectively to one input terminals of the optical processing units 23a and 23b in the fourth stage. Output terminals of the optical processing units 23a and 23b are optically coupled respectively to two input terminals of the optical processing unit 24 in the fifth stage. An output terminal of the optical processing unit 24 is optically coupled to the output port P#5. A configuration of each of the optical processing units 20a to 20d, 21a, 21b, 22a, 22b, 23a, 23b, 24, and 25 will be described below.

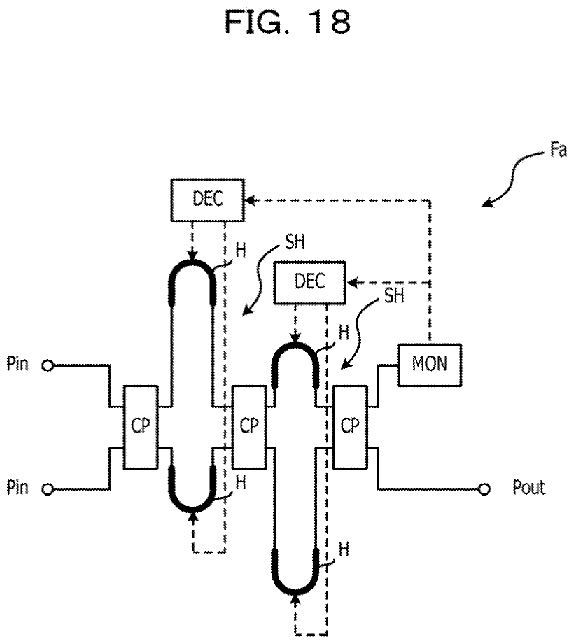

FIG. 18 is a configuration diagram illustrating an example of the optical processing units 20a to 20d, 21a, and 21b (simply referred to as Fa) having the two-stage configuration Fa. Each of the optical processing units 20a to 20d, 21a, and 21b having the two-stage configuration Fa includes a pair of input terminals Pin, an output terminal Pout, two optical phase shifters SH, two controllers DEC, a power detector MON, and three optical couplers CP. Each optical coupler CP has two input and two output ports.

The optical phase shifter SH is achieved by a pair of heaters H over a pair of waveguides of an asymmetric Mach-Zehnder interferometer, for example. As the temperature of the heater H increases, the optical path length of the waveguide increases, and thus the optical phase changes.

The optical phase shifters SH for two stages are optically coupled in cascade to each other via the optical coupler CP. The optical phase shifter SH in the first stage is coupled to the pair of input terminals Pin via the optical coupler CP, and the optical phase shifter SH in the second stage is coupled to the output terminal Pout and the power detector MON via the optical coupler CP.

Each of the optical phase shifters SH in the first stage and the second stage is controlled by an individual controller DEC. Each controller DEC controls the temperatures of a pair of heaters H such that the input power decreases in accordance with the output power of the signal light detected by the power detector MON. The controllers DEC and the power detector MON are achieved by electric circuits.

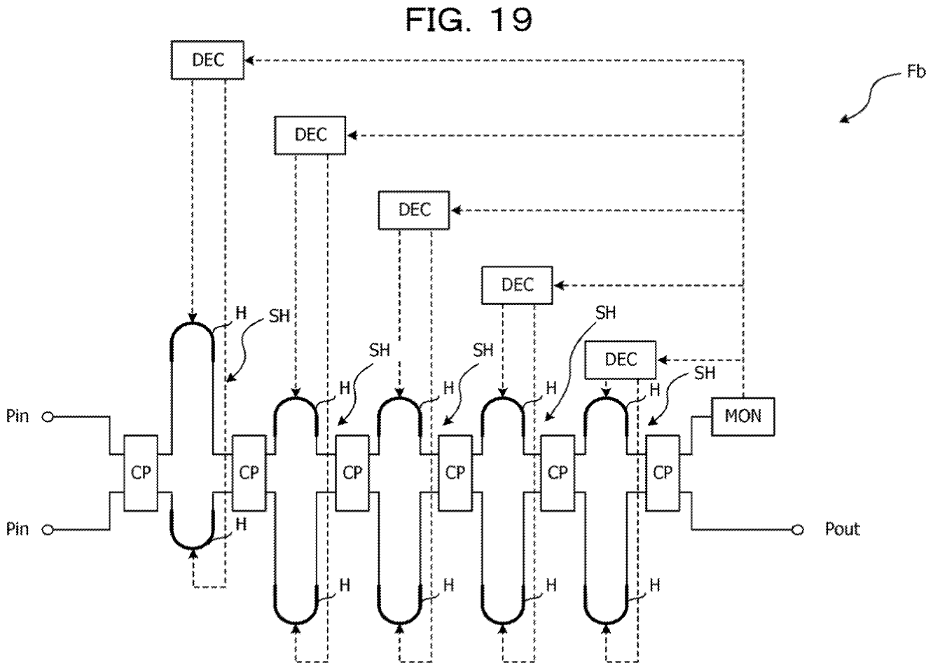

FIG. 19 is a configuration diagram illustrating an example of the optical processing units 22a, 22b, 23a, 23b, and 24 (simply referred to as Fb) having the five-stage configuration Fb. In FIG. 19, the same configurations as those in FIG. 18 are denoted by the same reference signs, and description thereof is omitted.

Each of the optical processing units 22a, 22b, 23a, 23b, and 24 having the five-stage configuration Fb includes a pair of input terminals Pin, an output terminal Pout, five optical phase shifters SH, five controllers DEC, a power detector MON, and six optical couplers CP.

The optical phase shifters SH for five stages are optically coupled in cascade to each other via the optical couplers CP. The optical phase shifter SH in the first stage is coupled to the pair of input terminals Pin via the optical coupler CP, and the optical phase shifter SH in the fifth stage is coupled to the output terminal Pout and the power detector MON via the optical coupler CP.

Each of the optical phase shifters SH in the first to fifth stages is controlled by an individual controller DEC. Each controller DEC controls the temperatures of a pair of heaters H such that the input power decreases in accordance with the output power of the signal light detected by the power detector MON.

As described above, since the optical processing units 20a to 20d, 21a, and 21b having the two-stage configuration Fa and the optical processing units 22a, 22b, 23a, 23b, and 24 having the five-stage configuration Fb change the optical path length by using the optical phase shifters SH in accordance with the result of monitoring the power of the signal light, it is possible to perform Nyquist shaping with less crosstalk.

As an example, the optical processing unit 25 having the one-stage configuration Fc has a configuration similar to that of the equalizer 102 illustrated in FIG. 10.

The optical processing unit 25 functions as an equalizer. By having a sinusoidal transmittance having the same period as the wavelength interval of the signal light beams #1 to #n, the optical processing unit 25 flattens the peak of the power of each signal light and causes the waveform to approach an ideal rectangular pulse. In this way, the spectrum efficiency of the wavelength-multiplexed signal light is improved.

Referring to FIG. 17 again, the optical processing units 20a to 20d, 21a to 23a, 21b to 23b, and 24 in the first to fifth stages of the multifunction optical filter 16 perform the spectrum shaping processing and the wavelength multiplexing processing on the signal light beams #1 to #n. The optical processing units 20a to 20d, 21a to 23a, 21b to 23b, and 24 are an example of a spectrum shaping unit that shapes the waveforms of the signal light beams #1 to #n such that the bandwidth of the spectrum of each of the signal light beams #1 to #n is equal to or less than the bandwidth corresponding to the symbol rate, and a multiplexing unit that multiplexes the signal light beams #1 to #n. The optical processing unit 25 is an example of an equalization unit, and performs equalization processing on the signal light beams #1 to #n.

Reference sign G1a indicates an example of spectra of four signal light beams respectively input from the input ports P#1 to P#4 to the optical processing units 20a to 20d. The center wavelengths of signal light at the respective input ports P#1 to P#4 are different from each other. The spectra of the signal light at the respective input ports P#1 to P#4 have side lobe components and overlap each other.

Reference sign G2b indicates an example of a spectrum of each signal light output from the optical processing unit 24 to the optical processing unit 25. Regions where the spectra of the signal light overlap each other are reduced by the waveform shaping of the optical processing units 20a to 20d, 21a to 23a, 21b to 23b, and 24 as compared with the spectra indicated by reference sign G1a.

Reference sign W indicates a sinusoidal transmittance of the optical processing unit 25 serving as an equalizer. A valley portion of the sine wave of the transmittance coincides with a peak of power of each signal light over the wavelength axis.

Reference sign G3b indicates an example of the spectrum of each signal light output from the optical processing unit 25 to the output port P#5. A peak of each signal light is flattened by the above-described characteristics of the transmittance.

For example, the optical processing units 20a to 20d, 21a to 23a, 21b to 23b, 24, and 25 are formed as optical integrated circuits over a common substrate. For this reason, the scale of the transmission device 9f is reduced as compared with the fifth embodiment.

(Examples of Other Optical DACs)

Each of the optical DACs 10 and 10g according to the above-described embodiments is an example, and other optical DACs may be used as described below.

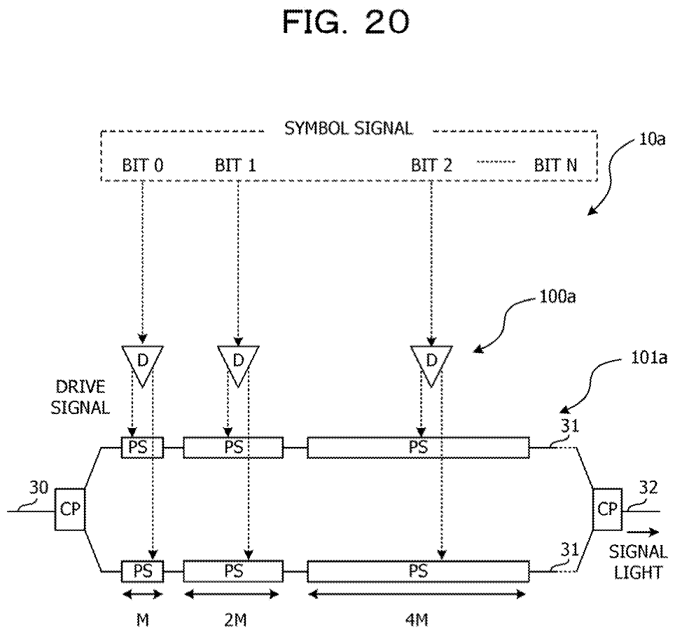

FIG. 20 is a configuration diagram illustrating an example of a binary-weighted optical DAC 10a. In FIG. 20, the same configurations as those in FIG. 4 are denoted by the same reference signs, and description thereof is omitted. The optical DAC 10a includes a binary driver 100a and a segment optical modulator 101a. The binary-weighted optical DAC 10a is described in, for example, the document “IEICE Technical Report OPE2013-12 LQE2013-22 (2013-6)”.

The binary driver 100a includes driver elements D provided for the respective bits 0 to N of each symbol signal. The driver elements D are provided for the respective bits 0 to N of each symbol signal. Each driver element D generates drive signals based on the symbol signals and outputs the drive signals to the segment optical modulator 101a.

The segment optical modulator 101a includes N optical phase shifters PS respectively corresponding to bits 0 to N in each branch waveguide 31. Drive signals are input to the respective optical phase shifters PS from the driver elements D corresponding to the same bits 0 to N. The length (segment length) of each optical phase shifter PS differs depending on the bits 0 to N. Assuming that the segment length of the optical phase shifter PS for the bit 1 is M, the segment length of the optical phase shifter PS for the bit i is M×2ⁱ⁻¹.

In the present example, as the number of bits of the symbol signal increases, not only do the numbers of the driver elements D and the optical phase shifters PS increase but also the segment lengths increase, so that the size of the segment optical modulator 101a increases. The optical phase shifters PS for the bits 0 to N are an example of a plurality of optical phase shift units. The driver elements D for the bits 0 to N are an example of a plurality of drive units that generate a plurality of drive signals based on a plurality of symbol signals and respectively output the drive signals to the optical phase shifters PS.

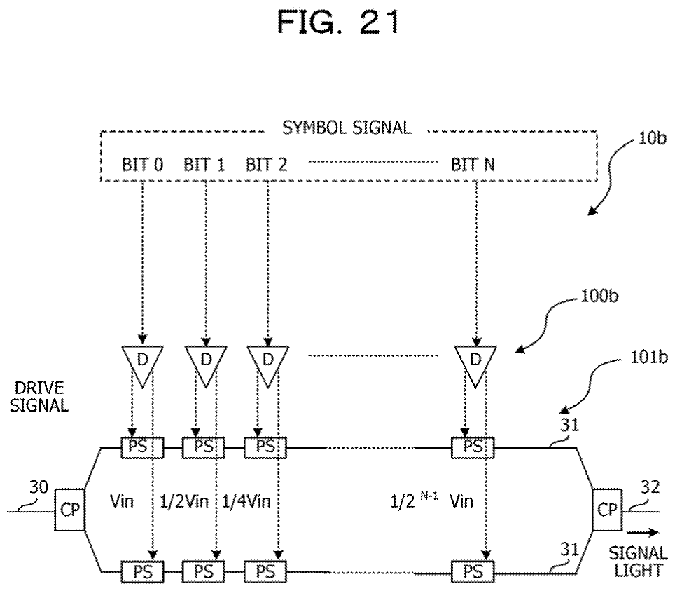

FIG. 21 is a configuration diagram illustrating an example of an optical DAC 10b in which weighting based on voltage amplitudes is performed. In FIG. 21, the same configurations as those in FIG. 4 are denoted by the same reference signs, and description thereof is omitted. The optical DAC 10b includes a binary driver 100b and a segment optical modulator 101b. The optical DAC 10b of this type is described in, for example, Japanese National Publication of International Patent Application No. 2018-523857 described above.

The binary driver 100a includes driver elements D provided for the respective bits 0 to N of each symbol signal. The driver elements D are provided for the respective bits 0 to N of each symbol signal. Each driver element D generates drive signals based on the symbol signals and outputs the drive signals to the segment optical modulator 101a. The voltage amplitude of the drive signal of each driver element differs depending on the bits 0 to N. Assuming that the voltage amplitude of the drive signal of the driver element for the bit 0 is Vin, the voltage amplitude of the drive signal of the driver element for the bit i is 1/2ⁱ⁻¹×Vin.

The segment optical modulator 101b includes N optical phase shifters PS respectively corresponding to the bits 0 to N in each branch waveguide 31. Drive signals are input to the respective optical phase shifters PS from the driver elements D corresponding to the same bits 0 to N. The length (segment length) of each optical phase shifter PS is the same irrespective of the bits 0 to N. The optical phase shift of signal light by each optical phase shifter PS is weighted by the voltage amplitude of a drive signal.

In the present example, as the number of bits of the symbol signal increases, the numbers of the driver elements D and the optical phase shifters PS increase. The optical phase shifters PS for the bits 0 to N are an example of a plurality of optical phase shift units. The driver elements D for the bits 0 to N are an example of a plurality of drive units that generate a plurality of drive signals based on a plurality of symbol signals and respectively output the drive signals to the optical phase shifters PS. The configurations of the optical DACs 10, 10a to 10d are not limited to those described above, and may be combined as appropriate.

(Example of Reduction in Number of Bits)

An example of reducing the number of bits according to each of the above-described embodiments will be described. In the present example, an IQ modulator using two thermometer-type optical DACs 10 illustrated in FIG. 4 is described.

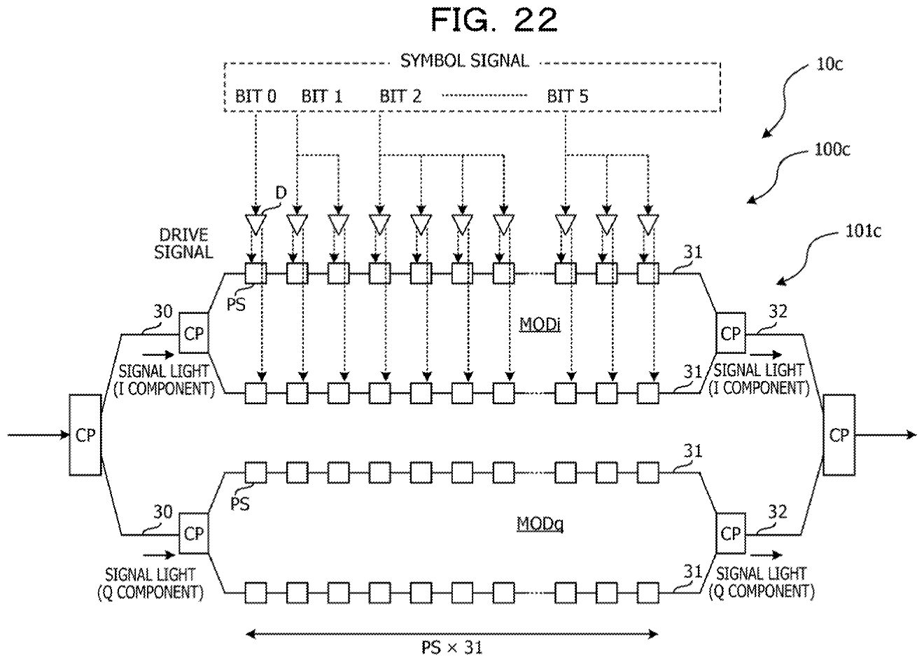

FIG. 22 is a configuration diagram illustrating an example of an optical DAC 10c corresponding to 5-bit symbol signals. In FIG. 22, the same configurations as those in FIG. 4 are denoted by the same reference signs, and description thereof is omitted.

The optical DAC 10c includes binary drivers 100c and a segment optical modulator 101c. The segment optical modulator 101c is an IQ modulator, and includes an I modulator MODi and a Q modulator MODq coupled to each other by the respective optical couplers CP on an input side and an output side.

An I component and a Q component of signal light are input to the I modulator MODi and the Q modulator MODq, respectively. Each of the I modulator MODi and the Q modulator MODq has a configuration similar to that of the thermometer-type optical DAC 10. Each of the I modulator MODi and the Q modulator MODq includes 31 optical phase shifters PS in each branch waveguide 31 so as to correspond to a 5-bit symbol signal.

The binary drivers 100c are coupled to the I modulator MODi and the Q modulator MODq. For the binary driver 100c, only the driver element D on the final stage is illustrated. The binary driver 100c coupled to the Q modulator MODq is not illustrated.

As described above, the optical DAC 10c that supports 5-bit symbol signals has a large-scale circuit configuration.

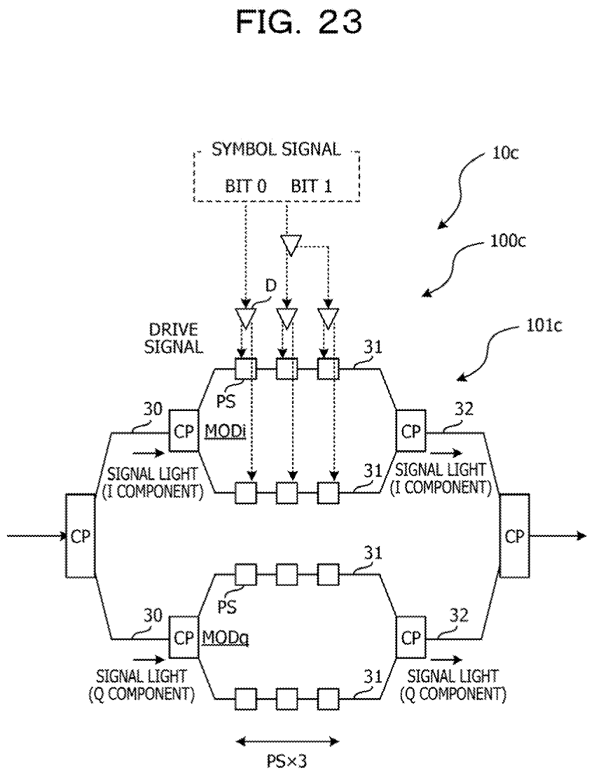

FIG. 23 is a configuration diagram illustrating an example of an optical DAC 10c corresponding to 2-bit symbol signals. In FIG. 23, the same configurations as those in FIG. 22 are denoted by the same reference signs, and description thereof is omitted.

Each of the I modulator MODi and the Q modulator MODq includes three optical phase shifters PS in each branch waveguide 31 so as to correspond to a 2-bit symbol signal. Each of the binary drivers 100c includes 57 driver elements D. The binary driver 100c coupled to the Q modulator MODq is not illustrated.

As described above, the optical DAC 10c that supports 2-bit symbol signals has a small-scale circuit configuration as compared with the 5-bit case described above.

As described above, when the scale of the optical DAC 10c is reduced by reducing the number of bits, not only power consumption but also a propagation loss is reduced.

For example, a case where the modulation method is 16QAM and the symbol rate (baud rate) is 64 (Gbaud) will be described. First, a configuration is assumed in which the spectrum shaping unit 11 is not provided and the signal processing unit 90 according to the second comparative example is provided instead of the signal processing unit 90 in the transmission device 9 according to the embodiment.

At this time, assuming that the sampling rate is 128 (GHz), the propagation loss and the power consumption of the optical DAC 10c are 17.9 (dB) and 643 (mW), respectively, when the symbol signals are 6 bits. The propagation loss and the power consumption of the optical DAC 10c are 22.0 (dB) and 1042 (mW), respectively, when the symbol signals are 7 bits. It is assumed that the segment length of the segment optical modulator 101 is adjusted such that the modulation degree is 0.5.

The transmission device 9 according to the embodiment is assumed next. At this time, assuming that the sampling rate is 64 (GHz), the propagation loss and the power consumption of the optical DAC 10c are 12.8 (dB) and 140 (mW), respectively, when the symbol signals are 2 bits. It is assumed that the segment length of the segment optical modulator 101 is adjusted such that the modulation degree is 0.46.

As described above, propagation loss and power consumption are reduced by reducing the number of bits.

The foregoing embodiments are preferred embodiments of the present disclosure. However, embodiments are not limited to these, and various modifications may be made without departing from the scope of the disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmitter, comprising:
an optical modulator including
a pair of waveguides of a Mach-Zehnder interferometer to which signal light is input, and
a plurality of optical phase shifters that are provided in each of the pair of waveguides and that each modulate a phase of the signal light with a plurality of drive signals;
a plurality of drivers that generate the plurality of drive signals based on a plurality of digital signals corresponding to a symbol to which data signals are mapped and output the plurality of drive signals to the plurality of optical phase shifters, respectively; and
a processor that shapes a waveform of the signal light such that a bandwidth of a spectrum of the signal light modulated by the optical modulator is equal to or less than a bandwidth corresponding to a rate of the symbol.

2. The optical transmitter according to claim 1, wherein
the data signal is mapped to a symbol according to a predetermined modulation method, and
the number of the plurality of drive signals is equal to the number of bits according to the predetermined modulation method.

3. The optical transmitter according to claim 1, wherein
the processor performs Nyquist filtering on the signal light.

4. The optical transmitter according to claim 1, further comprising:
a first equalizer that performs equalization processing on the signal light modulated by the optical modulator.

5. The optical transmitter according to claim 1, further comprising:
a second equalizer that performs equalization processing on the plurality of drive signals output from the plurality of drivers to the optical modulator.

6. The optical transmitter according to claim 1, further comprising:
a multiplexer that multiplexes the signal light modulated by the optical modulator with different signal light having a wavelength different from a wavelength of the signal light.

7. The optical transmitter according to claim 1, further comprising:
an equalizer that performs equalization processing on the signal light modulated by the optical modulator; and
a multiplexer that multiplexes the signal light modulated by the optical modulator with different signal light having a wavelength different from a wavelength of the signal light, wherein
the processor, the equalizer, and the multiplexer are integrated over a common substrate.

8. The optical transmitter according to claim 1, wherein
the processor is a wavelength selective switch in which a passband that allows the signal light to be transmitted is variable.

9. A transmission device, comprising:
a signal processor that maps a data signal to a symbol;
a light source of signal light;
an optical modulator including
a pair of waveguides of a Mach-Zehnder interferometer to which the signal light is input, and
a plurality of optical phase shifters that are provided in each of the pair of waveguides and that each modulate a phase of the signal light with a plurality of drive signals;
a plurality of drivers that generate the plurality of drive signals based on a plurality of digital signals corresponding to the symbol and output the plurality of drive signals to the plurality of optical phase shifters, respectively; and
a processor that shapes a waveform of the signal light such that a bandwidth of a spectrum of the signal light modulated by the optical modulator is equal to or less than a bandwidth corresponding to a rate of the symbol.

10. The transmission device according to claim 9, wherein
the data signal is mapped to a symbol according to a predetermined modulation method, and
the number of the plurality of drive signals is equal to the number of bits according to the predetermined modulation method.

11. The transmission device according to claim 9, wherein
the processor performs Nyquist filtering on the signal light.

12. The transmission device according to claim 9, further comprising:
a first equalizer that performs equalization processing on the signal light modulated by the optical modulator.

13. The transmission device according to claim 9, further comprising:
a second equalizer that performs equalization processing on the plurality of drive signals output from the plurality of drivers to the optical modulator.

14. The transmission device according to claim 9, further comprising:
a third equalizer that performs equalization processing on the symbol output from the signal processor to the plurality of drivers.

15. The transmission device according to claim 9, further comprising:
a multiplexer that multiplexes the signal light modulated by the optical modulator with different signal light having a wavelength different from a wavelength of the signal light.

16. The transmission device according to claim 9, further comprising:
an equalizer that performs equalization processing on the signal light modulated by the optical modulator; and
a multiplexer that multiplexes the signal light modulated by the optical modulator with different signal light having a wavelength different from a wavelength of the signal light, wherein
the processor, the equalizer, and the multiplexer are integrated over a common substrate.

17. The transmission device according to claim 9, wherein
the processor is a wavelength selective switch in which a passband that allows the signal light to be transmitted is variable.
